(19) United States
(12) Patent Application Publication
(10) Pub. No.: US 2001/0050651 A1
(43) Pub. Date: Dec. 13, 2001

(54) RADIOCOMMUNICATIONS DEVICE, AND A SLOT LOOP ANTENNA

(76) Inventors: CHRISTOPHE GRANGEAT, SEVRES (FR); CHARLES NGOUNOU KOUAM, LES ULIS (FR)

Correspondence Address: SUGHRUE MION ZINN MACPEAK & SEAS PLLC, 2100 PENNSYLVANIA AVENUE NW, SUITE 800, WASHINGTON, DC, 20037

(21) Appl. No.: 09/320,655

(22) Filed: May 27, 1999

(30) Foreign Application Priority Data
May 28, 1998 (FR) 98 06765

(51) Int. Cl. H01Q 13/10; H01Q 13/12

(52) U.S. Cl. 343/767; 343/769

(57) ABSTRACT

The antenna of this device is of the slot loop type. A conductive layer is deposited on the bottom surface of its substrate to reflect the waves transmitted or received by the resonating structure of the antenna. It is isolated from this structure to prevent parallel-plate resonance modes from being set up. A separator layer is fixed under the conductive layer to protect it from any capacitive coupling with other components of the device. It may be made of an insulating rigid foam. The invention applies to making a radiotelephone system.

The present invention relates generally to radiocommunications devices, in particular portable radiotelephones, and it relates more particularly to antennas that can be included in such devices.

### BACKGROUND OF THE INVENTION

Such an antenna is advantageously made using a planar technique which is applicable both to making lines conveying signals and also to making antennas for providing coupling between such lines and radiated waves. Such an antenna is formed by etching a conductive layer deposited on the top surface of a dielectric substrate.

A device of the invention includes more specifically a planar antenna provided with a loop-shaped resonant slot. Such an antenna is provided with a patch constituted by a fraction of said conductive layer. Said slot separates the patch from a conductive region constituted by another fraction of the same conductive layer. This region constitutes a ground plane of the antenna. It surrounds the patch almost entirely so that the resonant slot forms an open loop around the patch.

Antennas made using this technique constitute resonant structures suitable for being the seats of standing electromagnetic waves. The antenna uses the standing waves to perform its function which is to provide coupling with electromagnetic waves radiated in space. The standing waves can take various shapes corresponding respectively to various resonance modes of the structures. Each resonance mode can be described as resulting from the superposition of two waves propagating in opposite directions over the same path, and reflecting alternately at the two ends of the path. The path is defined by the elements making up the antenna. It is referred to below as the “resonance path”. It extends along the loop-shaped slot when the antenna is one of the above-mentioned antennas in the normal resonance mode. But it may also be rectilinear, e.g. when the antenna is one of said above-mentioned antennas in some other mode, or when it is some other antenna. In all cases, and for each mode, the resonance frequency is inversely proportional to the time taken for a travelling wave as considered above to travel along said resonance path.

A plurality of resonance waves may be set up over the same resonance path, and then cause a plurality of resonance frequencies to appear, corresponding respectively to the modes. Such a mode may be defined by a number which is referred to below as the “number of waves”, and which is the number of wavelengths of a wave whose frequency is equal to the resonance frequency corresponding to the mode, the number of wavelengths being the number contained in the length of the path. For each resonance path, the resonance frequency is thus proportional to said number. The number typically lies in the vicinity of a small integer number or of a fraction whose denominator is two or four. The term “resonance mode” is sometimes replaced below with the term “resonance”.

An antenna is coupled to a signal-processing member, i.e. a transmitter or a receiver, via a connection assembly which typically comprises a connection line external to the antenna and connecting it to said member. One end of the line forms a coupling device which is included in the antenna.

When the antenna is a transmitter antenna having a resonant structure, the respective functions of the coupling device, of the connection line, and of the antenna are as follows: the function of the connection line is to convey a radio-frequency or a microwave-frequency signal from the transmitter to the terminals of the antenna. All the way along such a line, the signal propagates in the form of a travelling wave without, at least in principle, being subjected to any significant modification in its characteristics.

The function of the coupling device is to transform the signal delivered by the connection line so that the signal excites resonance of the antenna, i.e. so that the energy of the travelling wave carrying the signal is transferred to a working standing wave that is set up in the antenna with characteristics defined thereby. The efficiency of such transfer depends on the impedance matching which must be implemented between the connection line and the resonant structure. Such matching is generally not perfect, i.e. the coupling device reflects a portion of the energy it receives back into the connection line, thereby giving rise to an unwanted or “stray” standing wave therein. The amplitude of the stray wave defines a standing wave ratio. The ratio varies as a function of frequency, and the plot of its variation with frequency defines the passband(s) of the antenna.

The antenna transfers the energy from the working standing wave to a wave radiated into space. The signal delivered by the transmitter is thus subjected to a first transformation to go from the form of a travelling wave to the form of a standing wave, and then to a second transformation which imparts the form of a radiated wave to it. When the antenna is a receiver antenna, the signal takes the same forms in the same members, but it takes them in the opposite order.

When the antenna is a planar antenna having a resonant slot in the form of an open loop, the coupling device is typically in the form of a coplanar line formed in the same conductive layer as the antenna. The line comprises a main conductor that is connected to the patch, and that is surrounded by two ground conductors which are connected to the antenna ground plane on either side of the opening in the loop.

With reference to transmitter antennas, the connection assembly of an antenna is often designated as constituting a feed line for the antenna.

The present invention relates to making various types of equipment. Such equipment is in particular constituted by portable radiotelephones, base stations therefor, motor vehicles, and aircraft or airborne missiles. In motor vehicles, and especially in aircraft or airborne missiles whose outside surfaces have curved profiles making it possible to obtain low aerodynamic drag, the antenna included in such equipment may be shaped to match the profile so as not cause any detrimental additional aerodynamic drag. However, it remains desirable for the transmit or receive lobes of the antenna to be directed towards the outside of the equipment. In a portable radiotelephone, it is more particularly desirable to limit the radiated power that is intercepted by the body of the user of the equipment when the equipment is used for transmission.

That is why a three-dimensionally asymmetrical distribution has been sought for the transmission power and the reception sensitivity of such antennas. To this end, auxiliary conductive layers have been associated with numerous known planar antennas having resonant slots in the form of loops. Such a layer is typically formed on the bottom surface of the substrate of the antenna. It then causes the waves transmitted by the antenna to be directed into the solid angle extending above the plane of the antenna.

A first such known antenna is described in U.S. Pat. No. 4,063,246 (Greiser). It comprises a rectangular patch. It is provided with a resonant slot in the form of a loop which surrounds the patch. The slot is the seat of a resonance mode that is set up along its length and that corresponds to a number of waves that is approximately equal to one. The auxiliary conductive layer of that antenna constitutes a lower ground plane because it is connected through the substrate to the upper ground plane which lies in the plane of the patch. The coupling with the radiated waves is achieved via the resonant slot. The slot is then said to be “radiative”. The ground plane of the antenna extends over a broad width from the resonant slot. That type of antenna is usually referred to as a “coplanar antenna”.

That first known antenna suffers, in particular, from the following drawbacks:

the need to provide connection means between the lower ground plane and the upper ground plane complicates manufacture; and

the dimensions of the antenna are greater than values desired in some of the above-mentioned uses.

In order to reduce the dimensions of such an antenna, a second known antenna differs from the first known antenna by the use of a different resonance mode. It is described in an article: Microwave and Optical Technology Letters/vol 6, No. 5, April 1993, page 292-294, “A Compact Slot Loop Antenna”, M. Cal, P. S. Kooi, and M. S. Leong. In that second known antenna, the number of waves of the resonance mode used is approximately ½, i.e. the perimeter of the patch extends over one half wavelength of the wave of the mode, which mode may be referred to as “half-wave resonance”. The radiative zone is then constituted mainly by the outer edges of the upper ground plane surrounding the patch, and the width of the upper ground plane must be limited for that purpose. The choice of the width makes it possible to match the impedance presented by the antenna to the connection assembly. The lower ground plane advantageously extends further than the upper ground plane so as to prevent large side lobes from appearing in the transmit-receive distribution in space. That type of antenna is referred to as a “slot loop antenna”.

That second known antenna suffers in particular from a drawback which can be common to the first known antenna and which is that only a fraction of the power injected into the antenna is useful in certain cases, i.e. only that fraction which is transferred in such cases to the desired half-wave resonance. Another fraction of the injected power may be a stray fraction which is transferred to stray resonance modes. While said half-wave resonance is set up on a path constituted by the slot loop with electric field lines extending between the patch and the upper ground plane, the stray modes are modes which are referred to as “parallel plate modes”. They are characterized in particular by electric field lines that extend through the substrate between the lower ground plane and the upper conductive layer which includes both the patch and the upper ground plane. Their resonance paths are also different from the path of the desired half-wave resonance. The existence of the stray fraction causes a decrease in the working power that is transmitted by the antenna at the desired frequency. In addition, interactions can occur between the various resonance modes. They can lead to unpredictable modifications in the frequency of the desired half-wave resonance.

The size of said stray power fraction depends on the various propagation speeds of the various resonance modes. It is known that such speeds depend on the dielectric constants of the materials through which the waves propagate. That is why, in order to avoid a power loss and/or a frequency modification caused by stray resonance, third and fourth known antennas differ from the preceding known antennas by the use of a plurality of materials having different dielectric constants.

The third known antenna is described in an article: ELECTRONICS LETTERS, vol. 32, No. 18, Aug. 29, 1996, P. 1633-1635, Forma et al. “Compact Oscillating slot loop antenna with conductor backing”. In addition to its dielectric substrate used to carry the upper conductive layer and the lower ground plane, it comprises another dielectric layer which covers the upper conductive layer and which has a dielectric constant that is higher than the dielectric constant of the substrate. The other dielectric layer is added for two purposes. The first purpose is to slow down the working travelling waves propagating along the slot loop at a small distance above and below the antenna plane. The other purpose is not to slow down the waves which propagate through the entire thickness of the substrate and which can give rise to stray modes. The effect of the resulting speed difference is to facilitate the desired half-wave resonance.

The fourth known antenna is described in an article: IEEE TRANSACTIONS ON ANTENNAS AND PROPAGATION, Vol. 43, No. 10, October 1995, p. 1143-1148, Liu et al. “Radiation of Printed Antennas with a Coplanar Waveguide Feed”. The purpose of the use of two dielectric layers is the same as in the third known antenna except that the two layers having different dielectric constants are interposed between the upper conductive layer and the lower ground plane. In other words, the substrate is then a composite substrate.

Those third and fourth known antennas suffer in particular from the drawback that the need to use two dielectric layers made of different materials complicates manufacture of the antenna.

### OBJECTS AND SUMMARY OF THE INVENTION

The present invention has, in particular, the following objects:

to make it possible, at low cost, to manufacture a compact and effective radiocommunications device, and in particular a mobile terminal that limits the radiation power liable to be absorbed by the body of a user of the terminal;

to make it possible, for that purpose, to manufacture an effective slot loop antenna that has a limited transmit-receive solid angle;

at least to limit the amplitude of stray resonance modes that are liable to be set up in such an antenna;

to make it possible to adjust a resonance frequency of the antenna easily and accurately; and

to limit the dimensions of the antenna.

To these ends, the present invention provides a radiocommunications device, the device comprising a slot loop antenna suitable for coupling electrical signals to radiated electromagnetic waves, the antenna comprising:

a resonance structure defining a working resonance frequency of the antenna, the structure extending in a surface constituting an antenna plane; and

an auxiliary conductive layer extending facing said resonant structure in a surface extending at a distance from said antenna plane;

said radiocommunications device further comprising a signal-processing member for processing said electrical signals;

wherein said auxiliary conductive layer is decoupled from said resonant surface and from said signal-processing member at least for any signal having a radio-frequency close to said working resonance frequency.

The present invention also provides a slot loop antenna, the antenna comprising:

a dielectric substrate having a bottom surface and a top surface;

an auxiliary conductive layer extending on said bottom surface of the substrate and having an area on said bottom surface; and

a top conductive layer extending over said top surface of the substrate and forming:

a patch, said auxiliary conductive layer being isolated from said patch; and

an antenna ground plane surrounding said patch while being separated therefrom by a slot, the slot constituting a resonant slot, the patch, the slot, and the antenna ground plane constituting a resonant structure, the structure having an area on said top surface of the substrate, the area being substantially included in said area of the axillary conductive layer;

wherein said auxiliary conductive layer is further isolated from said antenna ground plane so as to constitute a wave reflector for radiated electromagnetic waves transmitted or received by said resonant structure.

### BRIEF DESCRIPTION OF THE DRAWINGS

Various aspects of the present invention will be better understood on reading the following description with reference to the accompanying diagrammatic figures. When the same element is shown on more than one of the figures, it is designated therein by the same reference numerals and/or letters. In the figures:

FIG. 1 is a view of a radiocommunications device of the invention, an antenna of the device being shown in perspective;

FIG. 2 is a plan view of the antenna of the device shown in FIG. 1;

FIG. 3 is a view of the same antenna in section on a vertical plane III-III of FIG. 2; and

FIG. 4 is a plot showing how reflection coefficient expressed in decibels, and measured at the input of the same antenna, varies as a function of the frequency of a signal feeding the antenna, the frequency being expressed in MHz.

### MORE DETAILED DESCRIPTION

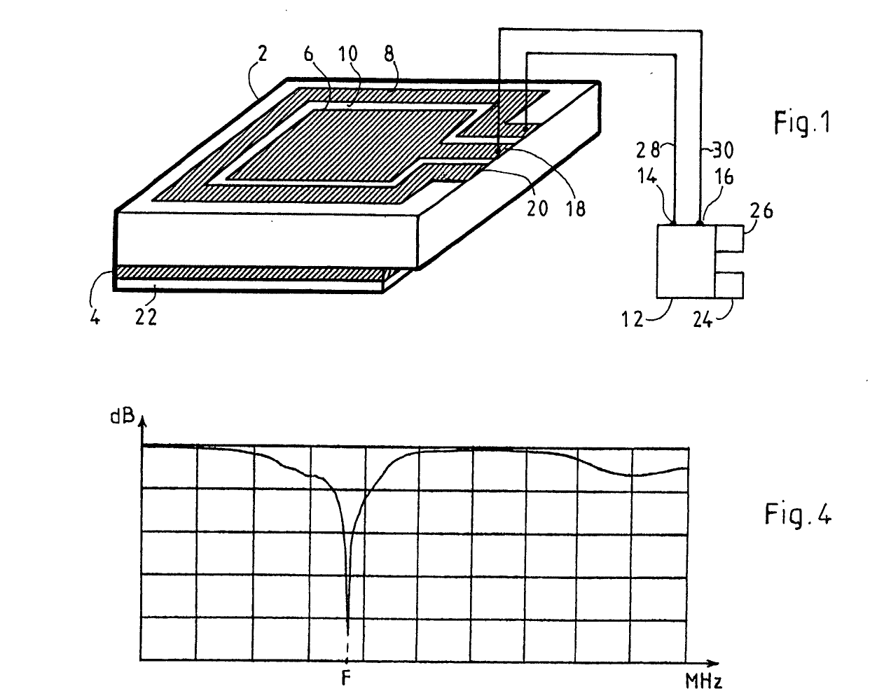

As shown in FIGS. 1, 2, and 3, and in a manner known per se, a slot loop antenna of the invention firstly comprises a resonant structure which itself comprises the following elements:

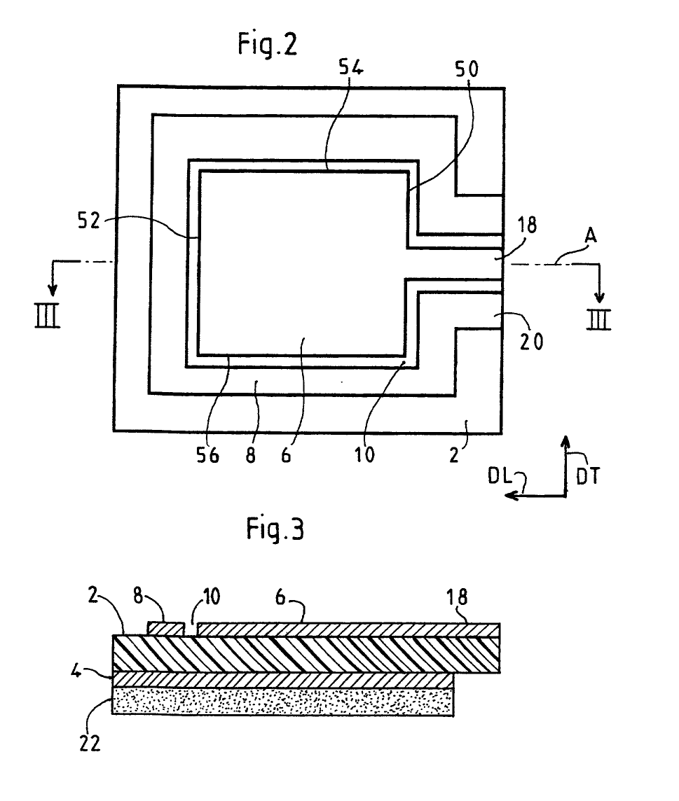

A dielectric substrate 2 having two mutually opposite main surfaces. These two main surfaces constitute respectively a bottom surface and a top surface. They extend in horizontal directions defined in this antenna and more precisely in a longitudinal direction DL and in a transverse direction DT, these two directions being shown in FIG. 2. The substrate is typically in the form of a rectangular plane sheet of uniform composition and of uniform thickness. However, this is not essential in any way. In particular, said surfaces may be curved, and the nature and thickness of the substrate may vary.

A bottom conductive layer 4 extending, for example over a fraction of the bottom surface of the substrate and constituting the above-mentioned auxiliary conductive layer. This layer has a top surface in contact with the substrate, and a bottom surface opposite from the top surface.

A first fraction of a top conductive layer extends over the top surface above the layer 4, and constitutes a patch 6. The patch has a length and a width extending respectively in the longitudinal direction DL and in the transverse direction DT, and its periphery is made up of four edges extending in pairs substantially in these two directions. Although the words “length” and “width” usually apply to the two mutually perpendicular directions of a rectangular object, with length being greater than width, it should be understood that the patch 6 may differ from a rectangular shape without going beyond the ambit of this invention. More particularly, the directions DL and DT may form an angle other than 90 degrees, the edges of the patch may be other than rectilinear and not separated by sharp-angled vertices, and the shape of the patch may also be circular or elliptical. One of the edges of the patch shown extends in the transverse direction DT and constitutes a rear edge 50. A front edge 52 extends opposite from the rear edge. Two side edges 54 and 56 join the rear edge to the front edge. The total length of all four sides constitutes a perimeter P of the patch.

A second fraction of said top conductive layer surrounds the patch 6. It constitutes an antenna ground plane 8. It is separated from the patch by a slot constituting a resonant slot 10. It extends over a limited distance starting from said slot. Said substrate, the patch, and the antenna ground plane define propagation speeds for electromagnetic waves propagating in said antenna along the slot. The width of the resonant slot is typically but not necessarily uniform. When it is uniform and when the characteristics of the substrate and of the ambient environment above the substrate are also uniform, the propagation speed of a wave is constant along the resonant slot. This speed then depends only on the frequency of the wave. The patch is typically in the form of a strip whose width is, for example, constant. Such a strip constitutes a ground strip. Its width is limited so that the antenna can be coupled to the radiated waves from an outer edge of the strip.

The antenna also comprises a coupling device. As is known in this type of antenna, the device is in the form of a coplanar-type transmission line. It comprises firstly a main conductor constituted by a longitudinal coupling strip 18 extending over the top surface of the substrate. The strip is connected to the patch 6 in the middle of said rear edge 50. The device also comprises a ground conductor 20 constituted by third and fourth fractions of the top conductive layer, these two fractions being situated on either side of the strip 18. the electric field lines of the travelling waves guided by the transmission line are then set up through two longitudinal slots separating the strip from the two fractions.

In a radiocommunications device, the coupling device constitutes all or some of a connection assembly which connects the resonant structure of the antenna to a signal-processing member. In the device given by way of example, this assembly further comprises a connection line which is external to the antenna.

FIG. 1, such a connection line external to the antenna is represented in the form of two conductor wires 28 and 30. The two wires connect the coupling strip 18 and the ground conductor 20 respectively to a signal terminal 14 and to a ground terminal 16 of the signal-processing member 12. But it should be understood that such a line is, in practice, preferably implemented in the form of a coplanar line, a microstrip line, or a coaxial line.

The signal-processing member 12 is suitable for operating at predetermined operating frequencies which are at least close to the working resonance frequency of the antenna, i.e. which lie in a passband centered on the resonance frequency. It may be composite, and then comprise an element tuned continuously to each of the operating frequencies. It may also comprise an element that can be tuned to the various operating frequencies. The resonance frequency F is such that the product P×F of this frequency multiplied by said perimeter P of the patch lies in the vicinity of one half V/2 of a mean propagation speed V of an electromagnetic wave having said frequency and propagating in the antenna along said resonant slot, i.e. the frequency is the frequency of a half-wave resonance.

In the present invention, said auxiliary conductive layer is decoupled from said resonant structure and from said signal-processing member at least for any signal having a radio-frequency, said operating frequencies constituting in particular such frequencies. The decoupling makes it possible for the layer to reflect said radiated electromagnetic waves without significantly degrading said working resonance frequency defined by said structure, so that the layer constitutes a wave reflector 4. This wave reflector function is different from that of the ground layers which extend over the bottom surfaces of the substrates of known slot loop antennas. This invention takes advantage of the fact that, when such a known antenna bottom layer enables parallel plate type stray modes to develop, it is because that layer is connected to the antenna ground plane formed by the top conductive layer.

Preferably, the area that is occupied by the wave reflector on the bottom surface of the substrate includes the area that is occupied by the resonant structure on the top surface of the substrate. In certain cases, it may advantageous for the area of the reflector to extend beyond the area of the resonant structure so as to limit very considerably radiated stray wave transmission to zones situated below the plane of the antenna. In other cases, it may be advantageous to cause the two areas to coincide substantially so as to make an antenna that is more compact while also limiting such stray wave transmission sufficiently.

Preferably, said area that is occupied by the wave reflector excludes the area that is occupied by said coupling device on the top surface of the substrate. This configuration prevents stray coupling from occurring between the resonant structure and the wave reflector via the coupling device.

Preferably, electrical isolation is provided between firstly said wave reflector and secondly:

said patch;

said antenna ground plane;

said signal terminal of the signal-processing member;

said ground terminal of said member;

said main conductor of the connection assembly; and

said ground conductor of said assembly.

Such isolation is effective both for DC and for AC. It contributes to limiting the risk of stray coupling. Means for implementing the isolation are constituted inter alia by the substrate 2 and by a separator layer 22 which is described below.

Preferably, the radiocommunications device further comprises spacer means for maintaining a predetermined decoupling distance between said wave reflector 4 and any object approaching the reflector on the bottom surface side thereof.

Preferably, said spacer means are constituted by an electrically-insulating separator layer 22 fixed to said bottom surface of the reflector 4, which layer has a thickness constituting said decoupling distance.

Preferably, said separator layer 22 is made of a material having relative permittivity of less than 2 and preferably in the vicinity of unity. In the invention, the thickness must be chosen to be large enough, and its dielectric constant represented by its relative permittivity must be chosen to be small enough to prevent or at least to limit stray capacitive coupling between the reflector and any component or conductor subjected to electrical potential variations at a radio-frequency. Such coupling is liable to occur when the component or the conductor can come into contact with the separator layer. Such components or conductors are in particular included in the signal-processing member. That is why, and for reasons of compactness, said separator layer 22 is preferably interposed between said wave reflector 4 and said signal-processing member 12. For example, it may be made of an organic polymer in the form of a rigid foam, or of a solid material of very low dielectric constant.

The radiocommunications device of the invention may in particular constitute a mobile terminal for a radiotelephone network. It then further comprises at least the following:

a microphone 24 for modulating an electrical signal transmitted by said signal processing means 12 to said slot loop antenna 1;

an earpiece 26 for delivering a sound signal representative of modulation of an electrical signal received by said signal-processing member from said antenna.

In which case, said wave reflector 4 is preferably interposed between said resonant structure 6, 8, 10 of the antenna and at least said earpiece. It is known that a fraction of the radiation transmitted by the antenna of a terminal may be intercepted by the head of a user of said terminal. The position of the wave reflector makes it possible at least to limit this fraction. More generally, the wave reflector is interposed, as is the separator layer, between the resonant structure and the remainder of a radiocommunications device.

In the context of a particular embodiment of an antenna of the invention, various configurations, compositions and values are indicated below. The lengths and widths are indicated respectively in the longitudinal direction DL and in the transverse direction DT. The antenna is symmetrical about an axis A. The substrate is rectangular and has four edges, namely a rear edge, a front edge, and two side edges, facing respective ones of the edges the patch that bear the same names. The edges of the top conductive layer coincide with those of the substrate. The wave reflector and the separator layer have front and side edges that coincide with those of the substrate. But the same does not apply to their rear edges:

resonance frequency F=1180 MHz;

input impedance: 50 Ohms;

composition of the substrate: epoxy resin having relative permittivity eᵣ equal to 4.3, and a dissipation factor tan δ equal to 0.03;

thickness of the substrate: 2 mm

thickness of the separator layer: 8 mm;

composition of the conductive layers: copper;

thickness of the layers: 17 microns;

length of the substrate: 42 mm;

width of the substrate: 50 mm;

length of the patch: 26 mm;

width of the patch: 33 mm;

length of the wave reflector and of the separator layer: 40 mm;

width of the resonant slot: 0.8 mm;

width of the ground strip: 5 mm;

width of the coupling strip: 5 mm; and

width of the slots situated on either side of the strip: 0.8 mm.

FIG. 4 was plotted using measurements taken on the antenna whose characteristics are indicated above. In the figure, the 0 dB level corresponds to the top horizontal line. The difference between two horizontal lines represents 10 dB. The extreme frequencies of the scale shown are 700 MHz and 2000 MHz. The resonance peak presented by the diagram corresponds to the above-indicated working resonance frequency F.

1. A radiocommunications device, the device comprising a slot loop antenna suitable for coupling electrical signals to radiated electromagnetic waves, the antenna comprising:
a resonance structure defining a working resonance frequency of the antenna, the structure extending in a surface constituting an antenna plane; and
an auxiliary conductive layer extending facing said resonant structure in a surface extending at a distance from said antenna plane;
said radiocommunications device further comprising a signal-processing member for processing said electrical signals;
wherein said auxiliary conductive layer is decoupled from said resonant surface and from said signal-processing member at least for any signal having a radio-frequency close to said working resonance frequency.

2. A radiocommunications device according to claim 1, the device comprising:
a dielectric substrate having a bottom surface and a top surface;
said auxiliary conductive layer, the layer having an area on said bottom surface of the substrate and constituting a wave reflector, the reflector having a top surface in contact with said substrate and a bottom surface opposite from said top surface; and
a top conductive layer extending over said top surface of the substrate and forming:
a patch having a perimeter;
an antenna ground plane surrounding said patch while being separated therefrom by a slot, the slot constituting a resonant slot, the ground plane extending over a limited distance from the slot, the patch, the slot, and the antenna ground plane constituting said resonant structure, the structure having an area on said top surface of the substrate, the area being included in said area of the wave reflector, the structure defining propagation speeds for the electromagnetic waves of the antenna propagating along the slot; and
a coupling device, the coupling device being in the form of a coplanar line having an area on said top surface of the substrate, the coupling device comprising:
a coupling strip that connects to said patch; and
a ground conductor that connects to said antenna ground plane and that extends on either side of said coupling strip while being separated therefrom by a slot on either side of said strip;
said signal-processing member comprising a signal terminal and a ground terminal and being tuned to transmit and/or to receive an electrical signal in the vicinity of said working resonance frequency of the antenna, the product of the working resonance frequency multiplied by said perimeter of the patch being in the vicinity of one half of a mean propagation speed of an electromagnetic wave having this frequency and propagating along said resonant slot;
wherein said area of the wave reflector excludes said area of the coupling device.

3. A radiocommunications device according to claim 2, the device comprising a connection assembly, the assembly comprising:
a main conductor including said coupling strip and connecting said signal terminal of the signal-processing member to said patch at least for any signal having a said radio frequency; and
a ground conductor including said ground conductor of the coupling device and connecting said ground terminal of the signal-processing member to said ground plane of the antenna at least for any signal having a said radio frequency;
said radiocommunications device comprising electrical isolation means for providing electrical isolation between firstly said wave reflector and secondly:
said patch;
said antenna ground plane;
said signal terminal of the signal-processing member;
said ground terminal of said member;
said main conductor of the connection assembly; and
said ground conductor of said assembly.

4. A radiocommunications device according to claim 2, said device further comprising spacer means for maintaining a predetermined decoupling distance between said wave reflector and any object approaching the reflector on the bottom surface side thereof.

5. A radiocommunications device according to claim 4, wherein said decoupling distance lies in the range 5 mm to 10 mm.

6. A radiocommunications device according to claim 4, wherein said spacer means are constituted by an electrically-insulating separator layer fixed to said bottom surface of the reflector, the layer having a thickness that constitutes said decoupling distance.

7. A radiocommunications device according to claim 6, wherein said separator layer is made of a material having relative permittivity of less than 2.

8. A radiocommunications device according to claim 6, wherein said separator layer is interposed between said wave reflector and said signal-processing member.

9. A radiocommunications device according to claim 6, the device constituting a mobile terminal for a radiotelephone network, and further comprising:
a microphone for modulating an electrical signal transmitted by said signal-processing means to said slot loop antenna; and
an earpiece for delivering a sound signal representative of modulation of an electrical signal received by said signal-processing member from said antenna;
said wave reflector being interposed between said resonant structure of the antenna and at least said earpiece.

10. A slot loop antenna, the antenna comprising:
a dielectric substrate having a bottom surface and a top surface;
an auxiliary conductive layer extending on said bottom surface of the substrate and having an area on said bottom surface; and
a top conductive layer extending over said top surface of the substrate and forming:
a patch, said auxiliary conductive layer being isolated from said patch; and
an antenna ground plane surrounding said patch while being separated therefrom by a slot, the slot constituting a resonant slot, the patch, the slot, and the antenna ground plane constituting a resonant structure, the structure having an area on said top surface of the substrate, the area being substantially included in said area of the axillary conductive layer;
wherein said auxiliary conductive layer is further isolated from said antenna ground plane so as to constitute a wave reflector for radiated electromagnetic waves transmitted or received by said resonant structure.

11. A slot loop antenna according to claim 10, the antenna further comprising a coupling device formed by said top conductive layer, the coupling device being in the form of a coplanar line having an area on said top surface of the substrate, the coupling device comprising:
a coupling strip that connects to said patch; and
a ground conductor that connects to said antenna ground plane and that extends on either side of said coupling strip while being separated therefrom by a slot on either side of said strip;
wherein said area of the wave reflector excludes said area of the coupling device.

12. A slot loop antenna according to claim 10, wherein said wave reflector carries an electrically-insulating separator layer on that side of the reflector which is further from said substrate.

13. A slot loop antenna according to claim 12, wherein said separator layer has a thickness lying in the range 5 mm to 10 mm.
